(19) United States
(12) Patent Application Publication
(10) Pub. No.: US 2010/0273598 A1
(43) Pub. Date: Oct. 28, 2010

(54) ELECTROMAGNETIC CLUTCH

(75) Inventor: Toshiaki KUSUDA, Akashi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Daiken Co., Ltd., Akashi (JP)

(21) Appl. No.: 12/763,463

(22) Filed: Apr. 20, 2010

(30) Foreign Application Priority Data
Apr. 23, 2009 (JP) 2009-104751
Feb. 18, 2010 (JP) 2010-033045

(51) Int. Cl. F16H 3/44

(52) U.S. Cl. 475/149; 475/298

(57) ABSTRACT

A clutch 100 includes: an internal gear 3 that includes a gear tooth formed on an inner-surface side thereof; a sun gear 4 that is disposed on the same shaft at a central portion of the inner side of the internal gear 3; one or more planetary gears 5 that are disposed between an outer circumferential surface of the sun gear 4 and an inner surface of the internal gear 3; a carrier 6 that is provided with a boss portion 6a that supports rotatably the planetary gear 5; an electromagnetic coil portion 7; a rotation limit member 8 that is slidably inserted into the electromagnetic coil portion 7 in a shaft direction and selectively disposed at a first position for limiting rotation of the internal gear 3 or the sun gear 4 or at a second position for permitting the rotations of the internal gear 3 and the sun gear 4; and an elastic member 9 that is disposed between the electromagnetic coil portion 7 and the first flange portion 8b of the rotation limit member 8.

### BACKGROUND OF THE INVENTION

This application is based on Japanese Patent Application No. 2009-104751 filed on Apr. 23, 2009 and No. 2010-33045 filed on Feb. 18, 2010, the contents of which are hereby incorporated by reference.

### FIELD OF THE INVENTION

The present invention relates to a planetary gear-type clutch that uses a planetary gear mechanism.

DESCRIPTION OF THE RELATED ART

Conventionally, in a case where a plurality of driven members are separately driven, if drive means like motors and the like, the number of which is equal to the number of driven members, are disposed, cost of an apparatus increases. To avoid this, it is general that the driven members are driven by using one drive means; and a clutch mechanism that performs transmission and interruption of drive force is disposed between the drive means and the driven members.

As a clutch mechanism, JP-A-2006-292120 discloses a planetary gear-type clutch that includes a planetary gear mechanism which is composed of: a rotatable internal gear; a sun gear that is rotatably disposed at a central portion of the internal gear; a planetary gear that meshes with the sun gear and an inner side of the internal gear and revolves around the sun gear while rotating on its own axis; and a carrier that rotatably supports the planetary gear.

In this planetary gear-type clutch, torque is transmitted by meshing between the gears that constitute the planetary gear mechanism, which does not need a grinding-in process and the like of a friction surface of a friction-type clutch in which a movable portion (armature) that engages with a drive input member is attracted and pressurized to and against a rotor (attraction plate) that is engaged with a drive output shaft, so that it is possible to achieve simplification of the production process and easy production control. Besides, there are advantages that it is possible not only to curb a change in torque transmission performance caused by environment and time-dependent change but also to have a speed-reduction function besides the clutch function.

### SUMMARY OF THE INVENTION

However, in the planetary gear-type clutch in the patent JP-A-2006-292120, because an electromagnetic solenoid that switches the internal gear to a stationary state or to a rotatable state is disposed separately from the planetary gear mechanism, the clutch mechanism becomes larger and the assembly workability deteriorates.

In light of the above problems, it is an object of the present invention to provide a planetary gear-type clutch that is easy to reduce thickness, size and is excellent in the assembly workability.

To achieve the above object, an electromagnetic clutch according to a first aspect of the present invention is a planetary gear-type electromagnetic clutch that includes: an internal gear which includes a gear tooth formed on an inner-surface side thereof and is rotatable: a sun gear that is disposed on the same shaft as the rotational shaft of the internal gear and includes a gear tooth formed on an outer circumferential surface thereof; a planetary gear that meshes with the sun gear and the internal gear; a carrier that rotatably supports the planetary gear and is rotatably disposed on the same shaft as the rotational shaft; a rotation limit member that is disposed on the same shaft as the rotational shaft and is selectively disposed at a first position for limiting rotation of the internal gear or the sun gear and at a second position for permitting the rotation of the internal gear and the sun gear; and a drive mechanism that is disposed on the same shaft as the rotational shaft and switches the rotation limit member to a first position or to a second position.

Still other objects of the present invention, specific advantages obtained by the present invention will be more apparent from the embodiments described below.

### DESCRIPTION OF THE DRAWINGS

FIG. 1 is an exploded perspective view of a planetary gear-type clutch according to a first embodiment of the present invention.

FIG. 2 is a side sectional view showing a state in which drive force is transmitted in the planetary gear-type clutch according to the first embodiment.

FIG. 3 is a side sectional view showing schematically FIG. 2.

FIG. 4 is a side sectional view showing a state in which the drive force is interrupted in the planetary gear-type clutch according to the first embodiment.

FIG. 5 is a side sectional view showing schematically FIG. 4.

FIG. 6 is a side sectional view schematically showing a state in which the drive force is interrupted in a planetary gear-type clutch according to a second embodiment of the present invention.

FIG. 7 is a side sectional view schematically showing a state in which the drive force is transmitted in a planetary gear-type clutch according to a third embodiment.

FIG. 8 is a side sectional view schematically showing a state in which the drive force is transmitted in a planetary gear-type clutch according to a fourth embodiment.

FIG. 9 is a side sectional view schematically showing a state in which the drive force is interrupted in the planetary gear-type clutch according to the fourth embodiment.

FIG. 10 is a side sectional view schematically showing a state in which the drive force is interrupted in a planetary gear-type clutch according to a fifth embodiment.

FIG. 11 is a side sectional view schematically showing a state in which the drive force is transmitted in a planetary gear-type clutch according to a sixth embodiment.

FIG. 12 is a side sectional view schematically showing a state in which the drive force is transmitted in a planetary gear-type clutch according to a seventh embodiment.

FIG. 13 is a side sectional view schematically showing a state in which the drive force is transmitted in a planetary gear-type clutch according to an eighth embodiment.

### DESCRIPTION OF THE PREFERRED EMBODIMENTS

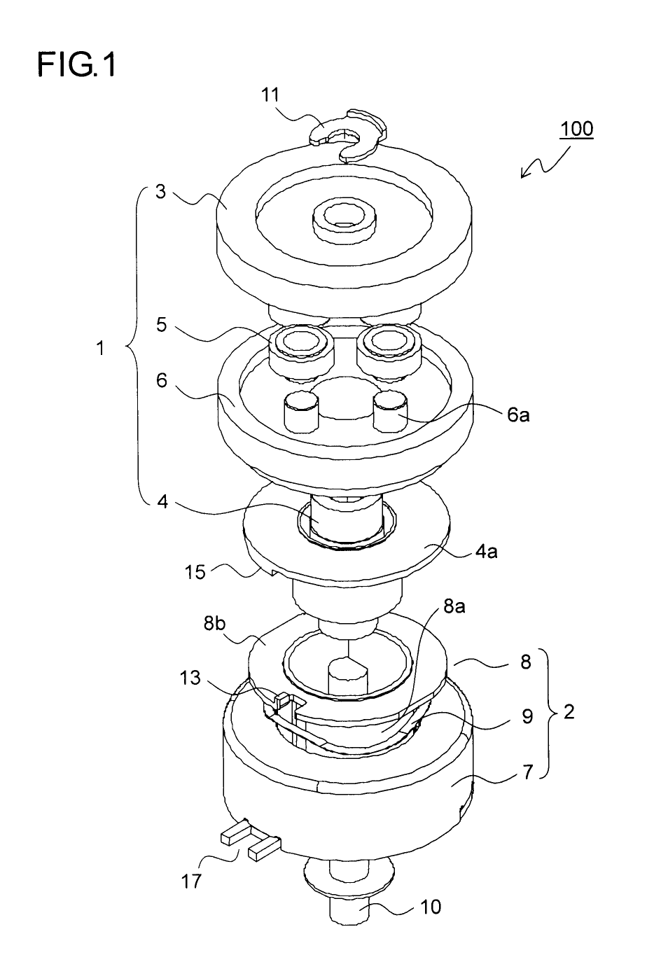

Hereinafter, the embodiments of the present invention are described with reference to the drawings. FIG. 1 is an exploded perspective view of a planetary gear-type clutch according to a first embodiment of the present invention. As shown in FIG. 1, a planetary gear-type clutch (hereinafter, simply called a clutch) 100 is an electromagnetic clutch that is composed of a planetary gear mechanism 1 and an electromagnetic solenoid 2. The planetary gear mechanism 1 is composed of: a internal gear 3 that includes gear teeth formed on an inner-surface side thereof; a sun gear 4 that is disposed on the same shaft at a central portion of the inner side of the internal gear 3; one or more (here, 4) planetary gears 5 that are disposed between an outer circumferential surface of the sun gear 4 and an inner surface of the internal gear 3; and a carrier 6 that is provided with a boss portion 6a that supports rotatably the planetary gear 5.

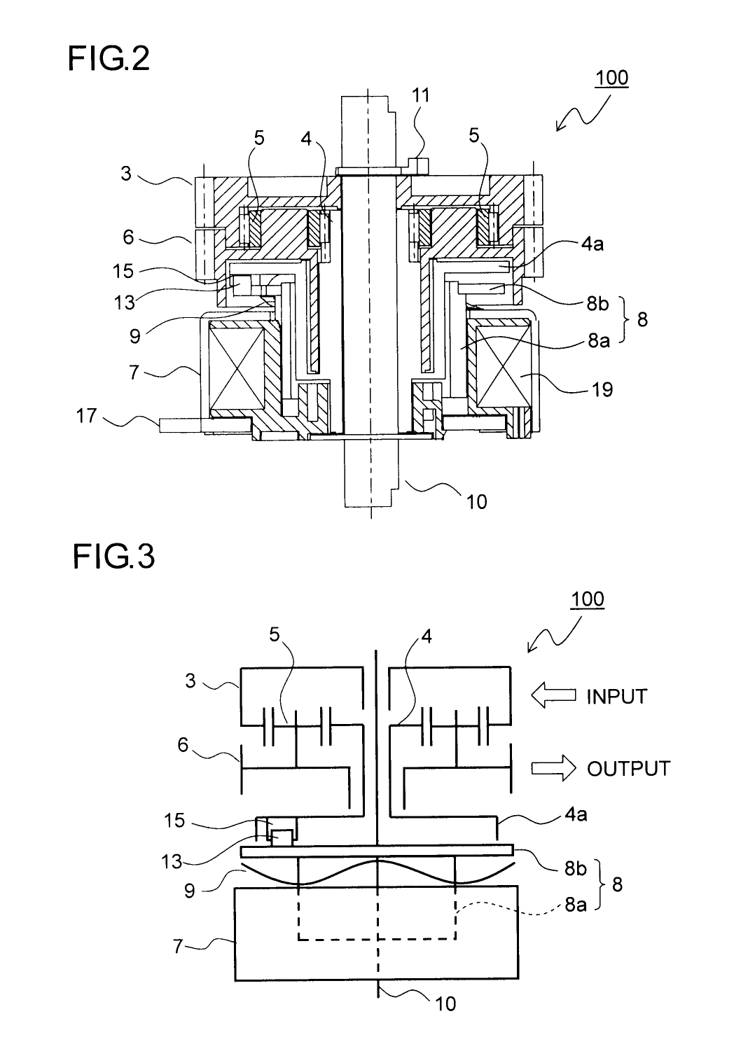

The electromagnetic solenoid 2 is composed of: an electromagnetic coil portion 7 that forms a magnetic circuit when electricity is supplied to an internal coil 19 (see FIG. 2); a rotation limit member 8 that is slidably inserted into the electromagnetic coil portion 7 in a shaft direction: and an elastic member 9 that is disposed between the electromagnetic coil portion 7 and a first flange portion 8b of the rotation limit member 8. The electromagnetic coil portion 7 and the elastic member 9 are drive mechanisms that reciprocate the rotation limit member 8 in the shaft direction.

And, a shaft 10 penetrates the center of the planetary gear mechanism 1 and the electromagnetic solenoid 2. and movements of the planetary gear mechanism 1 and the electromagnetic solenoid 2 in the shaft direction are limited by a stopper 11. Besides, the internal gear 3, the sun gear 4 and the carrier 6 are structured rotatably about the shaft 10.

The rotation limit member 8 is composed of a main body portion 8a that is formed into a cylindrical shape with a magnetic material such as iron or the like, a first flange portion 8b that is unitarily formed by extending an end portion that faces the sun gear 4 side in a radial direction; and an engagement portion 13 that protrudes toward the sun gear 4 side is formed on the first flange portion 8b. Besides, the rotation limit member 8 is permitted to only slide in the shaft direction of the shaft 10 along an inner surface of the electromagnetic coil portion 7 and hindered from rotating about the shaft 10.

The sun gear 4 is formed long in the shaft direction of the shaft 10 and a plate-shape portion 4a that protrudes in a radial direction is formed at substantially a central portion in the shaft direction. On a surface of the plate-shape portion 4a that faces the rotation limit member 8, a projection portion 15 is formed at a position to overlap the engagement portion 13 in the radial direction. In the projection portion 15, one end in a rotation direction is formed into a vertical surface that engages with the engagement portion 13 and the other end is formed into a tilted surface that does not interfere with the engagement portion 13; and two of each are formed point-symmetrically with respect to the shaft 10. And, when the sun gear 4 rotates forward and backward, one of the projections 15 is able to engage with the engagement portion 13.

The elastic member 9 is formed of a wave spring or the like, for example, and energizes the rotation limit member 8 in a direction to become away from the electromagnetic coil portion 7. Besides, on the housing of the electromagnetic coil portion 7, a rotation stopper 17 is formed to protrude and limits the rotation of the clutch 100 by engaging with a predetermined place of an apparatus main body when the clutch 100 is mounted on the apparatus main body.

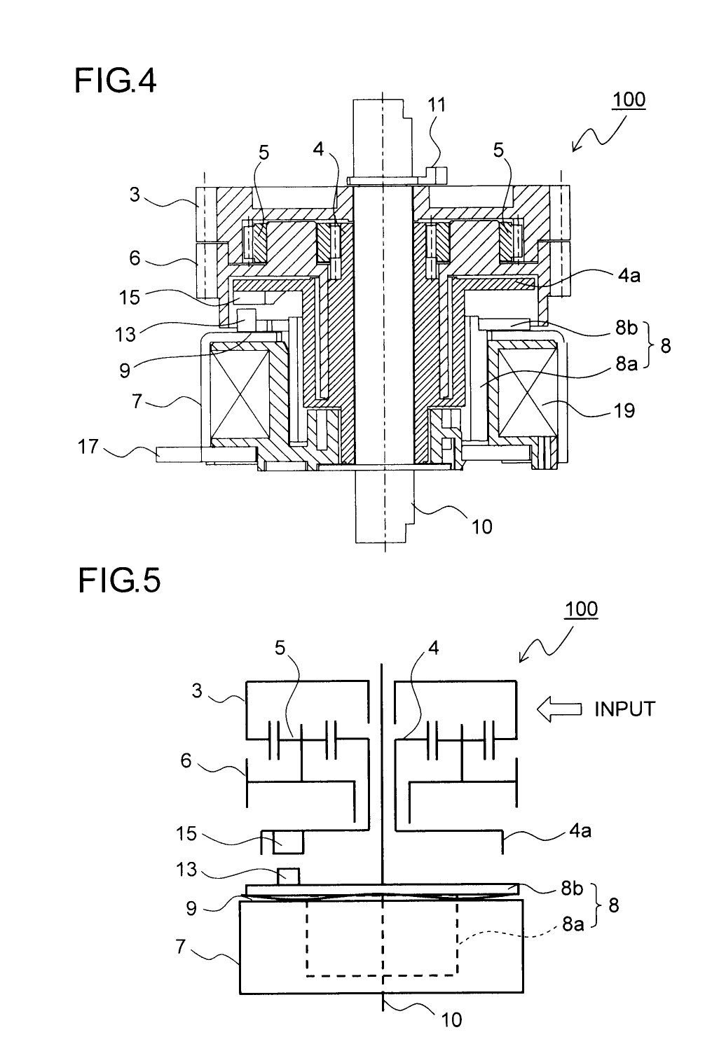

FIGS. 2 and 4 are side sectional views of the planetary gear-type clutch according to the first embodiment; and FIGS. 3 and 5 are views showing schematically FIGS. 2 and 4, respectively. Besides, FIGS. 2 and 3 show a state in which drive force is transmitted; and FIGS. 4 and 5 show a state in which the drive force is interrupted. By means of FIGS. 1 to 5, transmission and interruption mechanisms of the drive force (torque) in the planetary gear-type clutch according to the present invention are described. Here, the internal gear 3 is used as a drive force input side to which a drive gear and the like of a motor (not shown), which is a drive source for a driven input member, are connected and the carrier 6 is used as a drive output side to which the driven input member is connected.

In a state in which electricity is not supplied to the coil 19 in the electromagnetic coil portion 7 from an external power supply (not shown), because a magnetic circuit is not generated in the electromagnetic coil portion 7, only energizing force is given from the elastic member 9 to the rotation limit member 8 in a direction (upward direction in the figure) toward the sun gear 4. In this way, as shown in FIGS. 2 and 3, the engagement portion 13 of the first flange portion 8b engages with the projection portion 15 formed on the plate-shape portion 14a of the sun gear 4. so that the rotation limit member 8 is disposed at a position (hereinafter, called a first position) to limit rotation of the sun gear 4.

When the drive force is input to rotate the internal gear 3 in this state, the four planetary gears 5 which mesh with the teeth on the inner surface of the internal gear 3 also rotate (rotate on its axis) in the same direction as the internal gear 3 about each boss portion 6a. Because the planetary gear 5 meshes with the sun gear 4 as well, the drive force is also transmitted to the sun gear 4; however, because the rotation of the sun gear 4 is limited by the rotation limit member 8, the planetary gear 5 rotates on its axis and is given reaction from the sun gear 4 to revolve around the sun gear 4 in the rotation direction of the internal gear 3. As a result of this, the carrier 6 that supports the planetary gear 5 is slowed down at a predetermined speed-reduction ratio and rotated in the same rotation direction as the internal gear 3.

Specifically, when the electricity supply to the electromagnetic coil portion 7 is turned off, the electromagnetic solenoid 2 limits the rotation of the sun gear 4 of the planetary gear mechanism 1 to bring the clutch 100 into an ON state (connection state); slows down and transmits the rotation (torque) of the internal gear 3 on the drive input side to the carrier 6 on the drive output side, thereby driving and rotating the carrier 6 at a predetermined speed.

On the other hand, when electricity is supplied to the coil 19 in the electromagnetic coil portion 17 from the external power supply, because a magnetic circuit is generated in the electromagnetic coil portion 7, electromagnetic force acts on the rotation limit member 8 to compress the elastic member 9, so that the rotation limit member 8 is attracted to the electromagnetic coil portion 7. In this way, as shown in FIGS. 4 and 5, the rotation limit member 8 releases the engagement between the engagement portion 13 and the projection portion 15 to be disposed at a position (hereinafter, called a second position) which permits the rotation of the sun gear 4.

When the drive force is input to rotate the internal gear 3 in this state, the four planetary gears 5 also rotate (rotate on its axis) in the same direction as the internal gear 3 about each boss portion 6a. Besides, the drive force is also transmitted to the sun gear 4 that meshes with the planetary gear 5; however, because the sun gear 4 is permitted to rotate by the electromagnetic solenoid 2, the sun gear 4 rotates in a direction opposite to the planetary gear 5 with a load acting on the carrier 6. In other words, the planetary gear 5 is not subjected to reaction from the sun gear 4, only rotates on its axis at the place and does not revolve around the sun gear 4. As a result of this, the rotation (torque) of the internal gear 3 is not transmitted to the carrier 6, so that the carrier 6 maintains a stationary state.

Specifically, when the electricity supply to the electromagnetic coil portion 7 is turned on, the electromagnetic solenoid 2 permits the rotation of the sun gear 4 of the planetary gear mechanism 1 to bring the clutch 100 into an OFF state (interruption state); separates the internal gear 3 on the drive input side and the carrier 6 on the drive output side from each other, thereby interrupting the transmission of the rotation (torque) of the internal gear 3 to the carrier 6.

In the clutch 100 according to the present embodiment, the planetary gear mechanism 1 and the electromagnetic solenoid 2 are mounted on the same shaft. According to this structure, it is possible to improve the assembly workability and achieve the thickness and size reductions of the clutch 100 by reducing the disposition space of the electromagnetic solenoid 2.

Besides, because the clutch 100 goes into the ON state with the electricity supply to the electromagnetic coil portion 7 turned off, it is possible to shorten the electricity supply time in a use state in which the ON time of the clutch 100 is longer than the OFF time of the clutch 100, which contributes to reduction of the consumed power.

Mere, in the above embodiment, the internal gear 3 is used as the drive input side and the carrier 6 is used as the drive output side; however, it is also possible to use the carrier 6 as the drive input side and the internal gear 3 as the drive output side. In that case, because the rotation period of the internal gear 3 is faster than the revolution period of the planetary gear 5, the rotation speed of the drive output side is increased compared with the drive input side. Usually, the rotation speed of the drive input side is slowed down and output in many cases, and the structure in the first embodiment that is able to have both of the clutch function and the speed-reduction function is advantageous. It is possible to arbitrarily set the speed-reduction ratio of the drive output side to the drive input side by selecting a gear ratio between the internal gear 3 and the planetary gear 5.

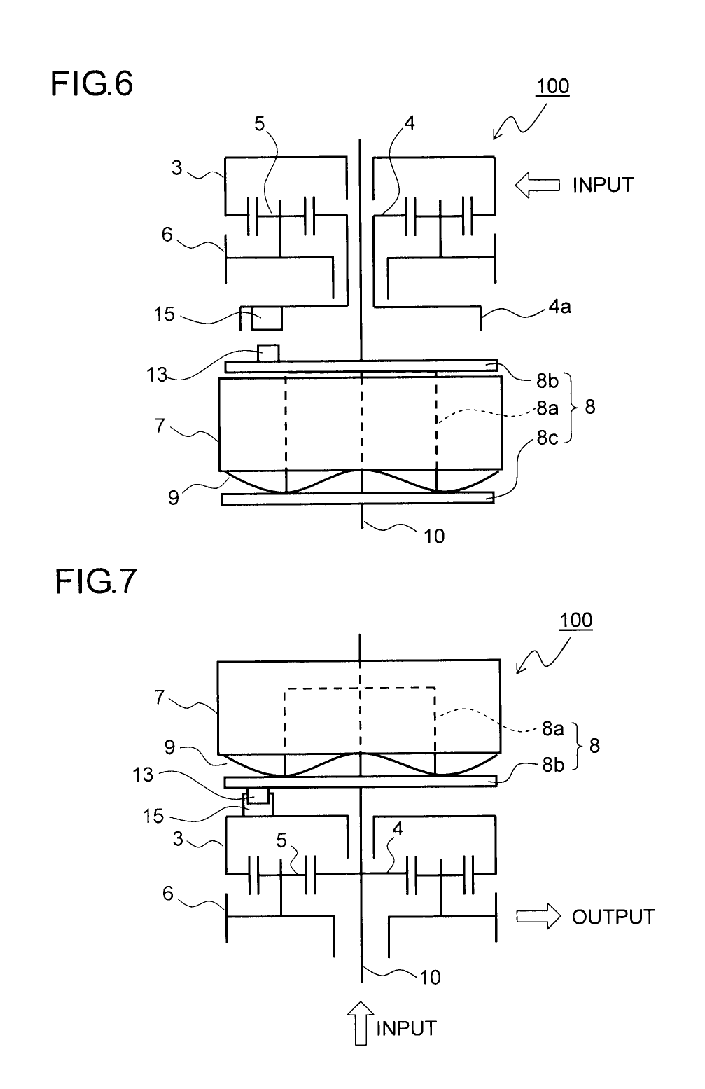

FIG. 6 is a schematic side sectional view of a planetary gear-type clutch according to a second embodiment of the present invention. The present embodiment uses the rotation limit member 8 that is provided with the first flange portion 8b of the main body portion 8a and the second flange portion 8c formed on an end portion opposite to the first flange portion 8b with the electromagnetic coil portion 7 interposed; and the elastic member 9 is disposed between the electromagnetic coil portion 7 and the second flange portion 8c. Because the structures of other portions are the same as those in the first embodiment, description of them is skipped.

In the present embodiment, the electricity supply to the electromagnetic coil portion 7 is turned off, so that the rotation limit member 8 is disposed at the second position by the energizing force of the elastic member 9 as shown in FIG. 6. In this way, the engagement between the engagement portion 13 and the projection portion 15 is released and free rotation of the sun gear 4 becomes possible, so that the drive transmission from the internal gear 3 to the carrier 6 is interrupted.

Besides, by turning on the electricity supply to the electromagnetic coil portion 7 in the state shown in FIG. 6, the second flange portion 8c is attracted to the electromagnetic coil portion 7 by the electromagnetic force to compress the elastic member 9, so that the rotation limit member 8 is disposed at the first position. In this way, the engagement portion 13 and the projection portion 15 engage with each other to limit the rotation of the sun gear 4, so that the drive transmission from the internal gear 3 to the carrier 6 becomes possible.

Accordingly, because the clutch 100 goes into the OFF state with the electricity supply to the electromagnetic coil portion 7 turned off, it is possible to reduce the consumed power in a use state in which the OFF time of the clutch 100 is longer than the ON time of the clutch 100. Besides, like in the first embodiment, because the planetary gear mechanism 1 and the electromagnetic solenoid 2 are mounted on the same shaft, it becomes advantageous to improvement of the assembly workability of the clutch 100, thickness and size reductions of the clutch 100.

FIG. 7 is a schematic side sectional view of a planetary gear-type clutch according to a third embodiment of the present invention. In the present invention, the electromagnetic solenoid 2 that includes the electromagnetic coil portion 7, the rotation limit member 8 and the elastic member 9 is disposed on the internal gear 3 side; and the engagement portion 13 formed on the first flange portion 8b of the rotation limit member 8 and the projection portion 15 formed on a side surface of the internal gear 3 engage with and disengage from each other. Besides, the shaft 10 unitarily formed with the sun gear 4 is used as the drive input side and the carrier 6 is used as the drive output side. Because the structures of other portions are the same as those in the first embodiment, description of them is skipped.

In the present embodiment, in a state in which electricity is not supplied from the external power supply to the electromagnetic coil portion 7, only energizing force is given from the elastic member 9 to the rotation limit member 8 in a direction (downward direction in FIG. 7) toward the internal gear 3. In this way, the engagement portion 13 of the first flange portion 8b engages with the projection portion 15 formed on a side surface of the internal gear 3, so that the rotation limit member 8 is disposed at the first position which limits rotation of the internal gear 3.

When drive force is input into the shaft 10 to rotate the sun gear 4 in this state, the four planetary gears 5 which mesh with the sun gear 4 also rotate (rotate on its axis) in the direction opposite to the sun gear 4 about each boss portion 6a. Here, because the rotation of the internal gear 3 is limited by the rotation limit member 8, the planetary gear 5 rotates on its axis and is given reaction from the internal gear 3 to revolve around the sun gear 4 in the rotation direction of the sun gear 4. As a result of this, the rotation (torque) is transmitted from the sun gear 4 to the carrier 6 via the planetary gear 5, so that carrier 6 is slowed down at a predetermined speed-reduction ratio and rotated in the same rotation direction as the sun gear 4 and the shaft 10.

On the other hand, when electricity is supplied to the electromagnetic coil portion 7, because a magnetic circuit is generated in the electromagnetic coil portion 7, electromagnetic force acts on the rotation limit member 8 to compress the elastic member 9, so that the rotation limit member 8 is attracted to the electromagnetic coil portion 7. In this way, the rotation limit member 8 releases the engagement between the engagement portion 13 and the projection portion 15 to be disposed at the second position which permits the rotation of the internal gear 3.

When the drive force is input into the shaft 10 to rotate the sun gear 4 in this state, the four planetary gears 5 also rotate (rotate on its axis) in the same direction as the sun gear 4 about each boss portion 6a. Besides, the drive force is also transmitted to the internal gear 3 that meshes with the planetary gear 5; however, because the internal gear 3 is permitted to rotate, the internal gear 3 rotates in the same direction as the planetary gear 5 with a load acting on the carrier 6. In other words, the planetary gear 5 is not subjected to reaction from the internal gear 3, only rotates on its axis at the place and does not revolve around the sun gear 4. As a result of this, the rotations (torque) of the sun gear 4 and the shaft 10 are not transmitted to the carrier 6, so that the carrier 6 maintains the stationary state.

In the present embodiment as well, like in the first and second embodiments, because the planetary gear mechanism 1 and the electromagnetic solenoid 2 are mounted on the same shaft, it becomes advantageous to improvement of the assembly workability of the clutch 100, thickness and size reductions of the clutch 100.

Besides, like in the second embodiment, the second flange portion 8c is formed on the rotation limit member and the elastic member 9 is disposed between the electromagnetic coil portion 7 and the second flange portion 8c, so that it is possible to reduce the consumed power in the use state in which the OFF time of the clutch 100 is longer than the ON time of the clutch 100.

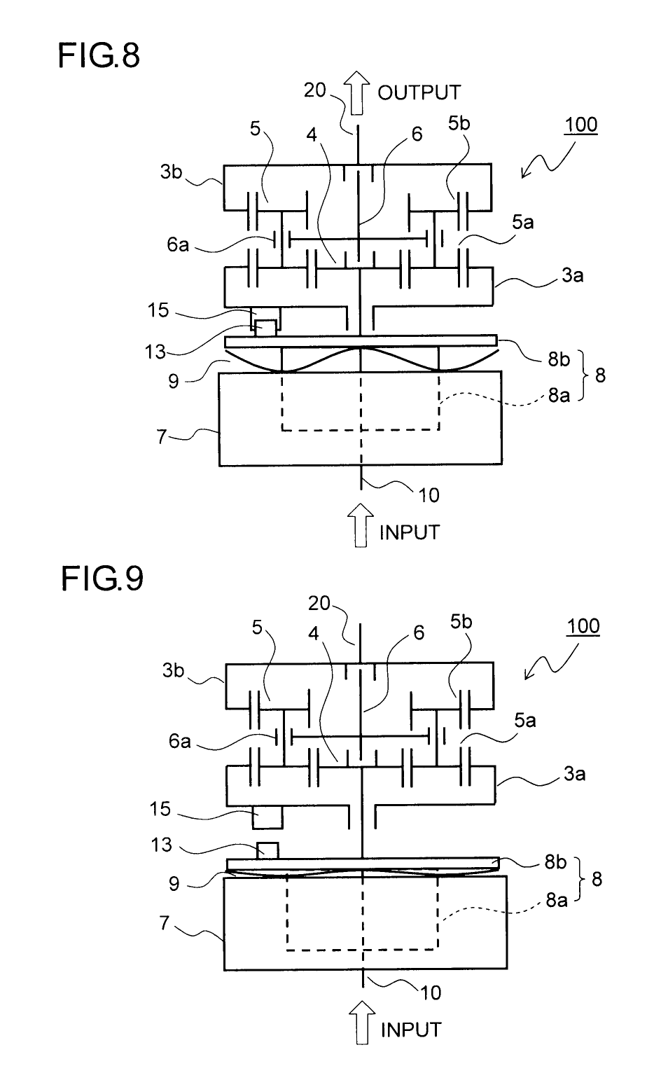

FIG. 8 is a schematic side sectional view of a planetary gear-type clutch according to a fourth embodiment of the present invention. In the present embodiment, as the planetary gear mechanism 1, a so-called mechanical paradox planetary gear mechanism in which two internal gears mounted on the same shaft mesh with a common planetary gear is employed. Specifically, the mechanical paradox planetary gear mechanism includes: a first internal gear 3a that is disposed adjacently to the rotation limit member 8 and meshes with a first mesh portion 5a of the planetary gear 5; and a second internal gear 3b that is disposed on a side opposite to the rotation limit member 8 with the first internal gear 3a interposed and meshes with a second mesh portion 5b of the planetary gear 5.

In a case where a plurality of gears are meshed, it is necessary to set the same module of each gear (the number of teeth of a gear/the diameter of a pitch circle). For example, in a case where the number of teeth of the first internal gear 3a is smaller than the number of teeth of the second internal gear 3b, the diameter of the pitch circle of the first internal gear 3a is designed small in accordance with the number of teeth.

The carrier 6 that is provided with the boss portion 6a (see FIG. 1) for supporting the planetary gear 5 is supported rotatably between the sun gear 4 and the second internal gear 3b. Besides, the shaft 10 unitarily formed with the sun gear 4 is used as the drive input side and the rotational shaft of the second internal gear 3b is protruded outward to be used as a drive output shaft 20. Because the structures of other portions are common to the first embodiment shown in FIGS. 1 to 3, description of them is skipped.

In the present embodiment, in the state in which electricity is not supplied from the external power supply to the electromagnetic coil portion 7, only energizing force is given from the elastic member 9 to the rotation limit member 8 in a direction (upward direction in FIG. 8) toward the first internal gear 3a. In this way, the engagement portion 13 of the first flange portion 8b engages with the projection portion 15 formed on a side surface of the first internal gear 3a, so that the rotation limit member 8 is disposed at the first position which limits rotation of the first internal gear 3a.

When the drive force is input into the shaft 10 to rotate the sun gear 4 in this state, the four planetary gears 5 which mesh with the sun gear 4 also rotate (rotate on its axis) in the direction opposite to the sun gear 4 about each boss portion 6a. Here, because the rotation of the first internal gear 3a is limited by the rotation limit member 8, the planetary gear 5 rotates on its axis and is given reaction from the first internal gear 3a to revolve around the sun gear 4 in the rotation direction of the sun gear 4. As a result of this, the rotation (torque) is transmitted from the sun gear 4 to the second internal gear 3b via the planetary gear 5, so that the second internal gear 3b is slowed down at a predetermined speed-reduction ratio and rotated in the same rotation direction as the sun gear 4 and the shaft 10.

On the other hand, when electricity is supplied to the electromagnetic coil portion 7, because a magnetic circuit is generated in the electromagnetic coil portion 7, electromagnetic force acts on the rotation limit member 8 to compress the elastic member 9, so that the rotation limit member 8 is attracted to the electromagnetic coil portion 7. In this way, the rotation limit member 8 releases the engagement between the engagement portion 13 and the projection portion 15 to be disposed at the second position which permits the rotation of the first internal gear 3a.

When the drive force is input into the shaft 10 to rotate the sun gear 4 in this state, the four planetary gears 5 also rotate (rotate on its axis) in the same direction as the sun gear 4 about each boss portion 6a. Besides, the drive force is also transmitted to the first internal gear 3a that meshes with the planetary gear 5; however, because the first internal gear 3a is permitted to rotate, the first internal gear 3a rotates in the same direction as the revolving-around direction of the planetary gear 5 with a load acting on the second internal gear 3b. In other words, the planetary gear 5 is not subjected to reaction from the first internal gear 3a, only rotates on its axis at the place and does not revolve around the sun gear 4. As a result of this, the rotations (torque) of the sun gear 4 and the shaft 10 are not transmitted to the second internal gear 3b, so that the drive output shaft 20 does not rotate.

In the present embodiment as well, like in the first to third embodiments, because the planetary gear mechanism 1 and the electromagnetic solenoid 2 are mounted on the same shaft, it becomes advantageous to improvement of the assembly workability of the clutch 100, thickness and size reductions of the clutch 100.

Besides, because the mechanical paradox planetary gear mechanism is employed as the planetary gear mechanism 1, a higher speed-reduction ratio than the first to third embodiments is obtained, so that it is not necessary to dispose a speed-reduction mechanism between the clutch 100 and the motor and it becomes advantageous to the size reduction and space saving of the drive apparatus that includes the clutch 100; and it becomes advantageous in terms of the cost because the number of components is able to be reduced.

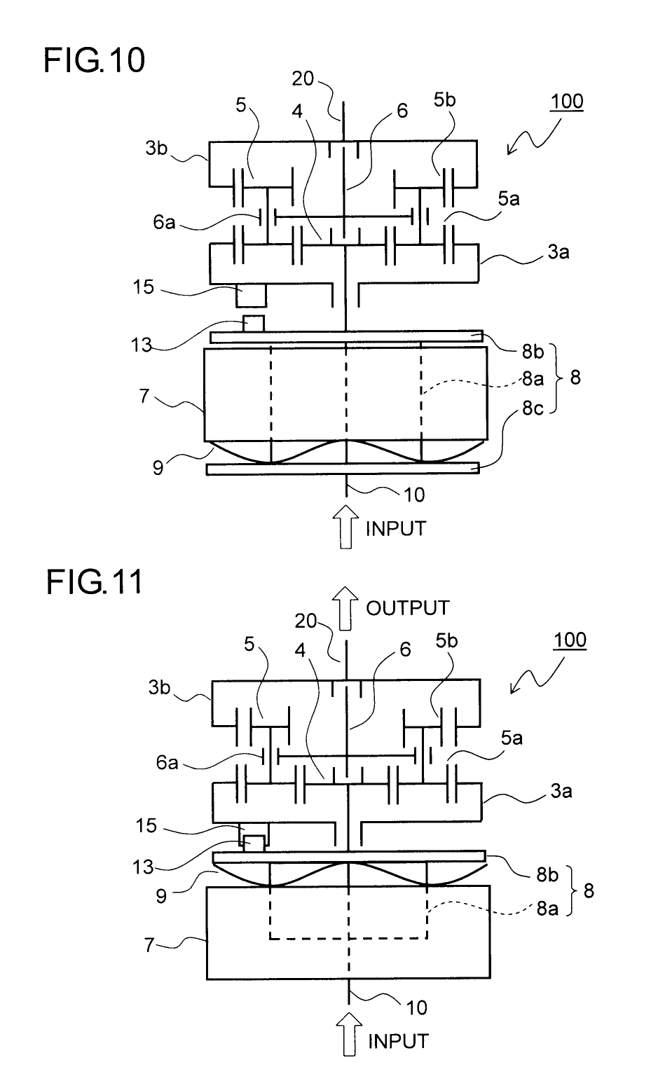

FIG. 10 is a schematic side sectional view of a planetary gear-type clutch according to a fifth embodiment of the present invention. The present embodiment uses the rotation limit member 8 that is provided with the first flange portion 8b of the main body portion 8a and the second flange portion 8c formed on an end portion opposite to the first flange portion 8b with the electromagnetic coil portion 7 interposed; and the elastic member 9 is disposed between the electromagnetic coil portion 7 and the second flange portion 8c. Because the structures of other portions are the same as those in the fourth embodiment, description of them is skipped.

In the present embodiment, by turning off the electricity supply to the electromagnetic coil portion 7, the rotation limit member 8 is disposed at the second position by the energizing force of the elastic member 9 as shown in FIG. 10. In this way, the engagement between the engagement portion 13 and the projection portion 15 is released and free rotation of the first internal gear 3a becomes possible, so that the drive transmission from the sun gear 4 to the second internal gear 3b is interrupted.

Besides, by turning on the electricity supply to the electromagnetic coil portion 7 in the state shown in FIG. 10, the second flange portion 8c is attracted to the electromagnetic coil portion 7 by the electromagnetic force to compress the elastic member 9, so that the rotation limit member 8 is disposed at the first position. In this way, the engagement portion 13 and the projection portion 15 engage with each other to limit the rotation of the first internal gear 3a, so that the drive transmission from the sun gear 4 to the second internal gear 3b becomes possible.

Accordingly, because the clutch 100 goes into the OFF state with the electricity supply to the electromagnetic coil portion 7 turned off, like in the second embodiment, it is possible to reduce the consumed power in the use state in which the OFF time of the clutch 100 is longer than the ON time of the clutch 100. Besides, because the mechanical paradox planetary gear mechanism is employed like in the fourth embodiment, it is possible to obtain a higher speed-reduction ratio, so that it becomes advantageous to improvement of the assembly workability of the clutch 100, thickness and size reductions of the clutch 100.

Here, the rotational shaft of the second internal gear 3b is extended to form the drive output shaft 20; however, it is also possible to form gear teeth on the outer circumferential surface of the second internal gear 3b to be used as the drive output side.

FIG. 11 is a schematic side sectional view of a planetary gear-type clutch according to a sixth embodiment of the present invention. In the present embodiment, the number of teeth of the first mesh portion 5a of the planetary gear 5 and the number of teeth of the second mesh portion 5b of the planetary gear 5 are different from each other; the number of teeth of the first mesh portion 5a that meshes with the first internal gear 3a is larger than the number of teeth of the second mesh portion 5b that meshes with the second internal gear 3b. Because the structures of other portions of the clutch and the transmission and interruption mechanisms of the drive force (torque) are the same as those in the fourth embodiment, description of them is skipped.

In the present embodiment, the number of teeth of the first mesh portion 5a of the planetary gear 5 and the number of teeth of the second mesh portion 5b of the planetary gear 5 are different from each other, so that it is possible to arbitrarily set the speed-reduction ratio of the drive output side to the drive input side with a simple structure. When the number of teeth of the sun gear 4 is Za, the number of teeth of the first mesh portion 5a of the planetary gear 5 is Zb, the number of teeth of the first internal gear 3a is Zc, the number of teeth of the second mesh portion 5b of the planetary gear 5 is Zd, and the number of teeth of the second internal gear 3b is Ze, the speed-reduction ratio U is expressed by the following formula (1).

U=Za·(Zb·Ze−Zc·Zd)/Zb·Ze(Za+Zc) (1)

Accordingly, it is possible to obtain a desired speed-reduction ratio by suitably setting the number of teeth of the respective gears Za to Ze. For example, when Za=21, Zb=19, Zc=59, Zd=17 and Ze=59, U=21×(19×59−59×17)/19×59×(21+59)≈36.19, that is, a speed-reduction ratio of about 1/36 is obtained.

Besides, like in the fifth embodiment, the second flange portion 8c is formed on the rotation limit member and the elastic member 9 is disposed between the electromagnetic coil portion 7 and the second flange portion 8c, so that it is possible to reduce the consumed power in the use state in which the OFF time of the clutch 100 is longer than the ON time of the clutch 100.

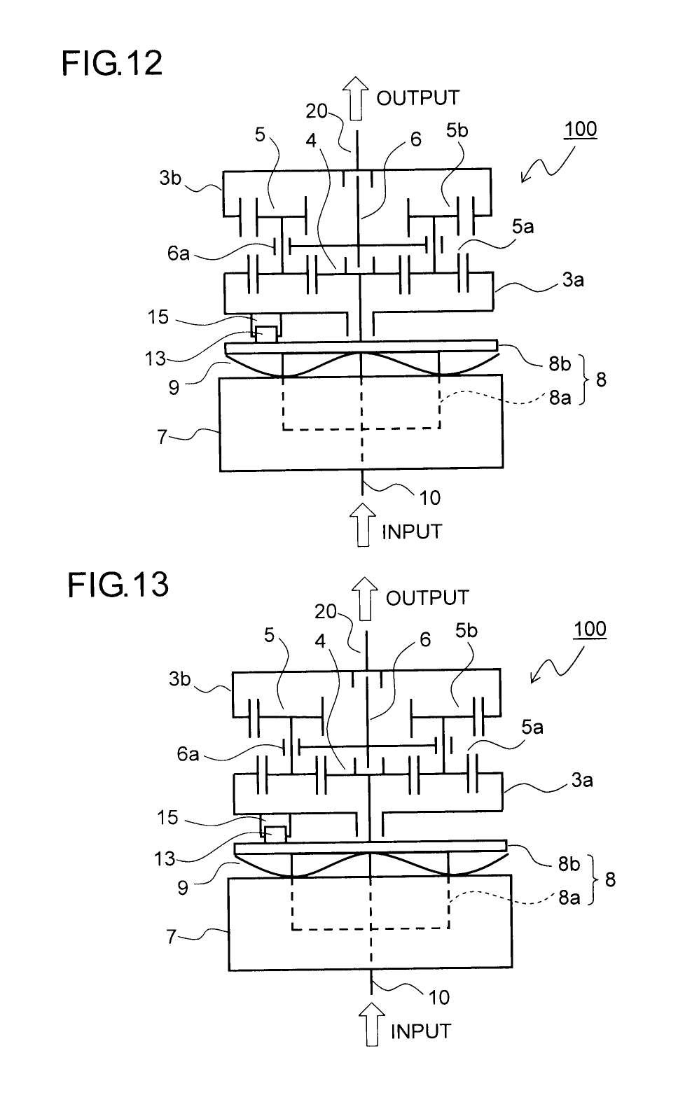

FIG. 12 is a schematic side sectional view of a planetary gear-type clutch according to a seventh embodiment of the present invention. In the present embodiment, the number of teeth of the first internal gear 3a and the number of teeth of the second internal gear 3b are different from each other: the number of teeth of the second internal gear 3b that meshes with the second mesh portion 5b is larger than the number of teeth of the first internal gear 3a that meshes with the first mesh portion 5a. Because the structures of other portions of the clutch and the transmission and interruption mechanisms of the drive force (torque) are the same as those in the fourth embodiment, description of them is skipped.

In the present embodiment as well, the number of teeth of the first internal gear 3a and the number of teeth of the second internal gear 3b are different from each other, so that it is possible to arbitrarily set the speed-reduction ratio of the drive output side to the drive input side with a simple structure based on the above formula (1).

FIG. 13 is a schematic side sectional view of a planetary gear-type clutch according to an eighth embodiment of the present invention. In the present embodiment, the number of teeth of the first internal gear 3a and the number of teeth of the internal gear 3b are different from each other; and the planetary gear 5 has a two-difference structure in which the number of teeth of the first mesh portion 5a and the number of teeth of the second mesh portion 5b are different from each other. Specifically, the number of teeth of the second internal gear 3b is larger than the number of teeth of the first internal gear 3a; and the number of teeth of the second mesh portion 5b that meshes with the second internal gear 3b is larger than the number of teeth of the first mesh portion 5a that meshes with the first internal gear 3a. Because the structures of other portions of the clutch and the transmission and interruption mechanisms of the drive force (torque) are the same as those in the fourth embodiment, description of them is skipped.

In the present embodiment as well, the number of teeth of the first internal gear 3a, the number of teeth of the second internal gear 3b, the number of teeth of the first mesh portion 5a of the planetary gear 5 and the number of teeth of the second mesh portion 5b of the planetary gear 5 are suitably changed, so that it is possible to arbitrarily set the speed-reduction ratio of the drive output side to the drive input side with a simple structure based on the above formula (1).

Besides, in the seventh and eighth embodiments as well, like in the fifth embodiment, the second flange portion 8c is formed on the rotation limit member 8 and the elastic member 9 is disposed between the electromagnetic coil portion 7 and the second flange portion 8c, so that it is possible to reduce the consumed power in the use state in which the OFF time of the clutch 100 is longer than the ON time of the clutch 100.

Besides, the present invention is able to be modified in various way without departing from the spirit of the present invention. For example, in each of the above embodiments, the drive mechanism of the rotation limit member 8 is formed by using the electromagnetic coil portion 7 and the elastic member 9; however, it is possible to use another drive mechanism. For example, in a case where a mechanism that drives the rotation limit member 8 with a motor by using a combination of a rack gear and a pinion gear or an eccentric cam, electricity is consumed only when the dive transmission and the drive interruption are switched, so that it is possible to further reduce the consumed power of the clutch 100.

The present invention is summed up from each of the above embodiments as follows. In other words, an electromagnetic clutch according to an embodiment of the present invention includes: an internal gear which includes a gear tooth formed on an inner-surface side thereof and is rotatable; a sun gear that is disposed on the same shaft as the rotational shaft of the internal gear and includes a gear tooth formed on an outer circumferential surface thereof; a planetary gear that meshes with the sun gear and the internal gear; a carrier that rotatably supports the planetary gear and rotatably disposed on the same shaft as the rotational shaft; a rotation limit member that is disposed on the same shaft as the rotational shaft and is selectively disposed at a first position for limiting rotation of the internal gear or the sun gear

and at a second position for permitting rotation of the internal gear and the sun gear; and a drive mechanism that is disposed on the same shaft as the rotational shaft and switches the rotation limit member to a first position or to a second position.

According to this structure, the rotation limit member and the drive mechanism that switches the disposition of the rotation limit member to the first position or to the second position are mounted on the same shaft as the rotational shaft of the internal gear and the sun gear that constitute the planetary gear mechanism, so that it is possible to improve the assembly workability of the planetary gear-type clutch and achieve the thickness and size reductions of the clutch.

Besides, in the electromagnetic clutch having the above structure according to an embodiment of the present invention, the rotation limit member is formed of a magnetic material and the drive mechanism is composed of: an elastic member that energizes the rotation limit member to the first position or the second position; and an electromagnetic coil portion that forms a magnetic circuit by being supplied with electricity to move the rotation limit member in a direction opposite to energizing force of the elastic member.

According to this structure, the planetary gear-type electromagnetic clutch that is able to be ON/OFF controlled with a simple structure is achieved.

Besides, in the electromagnetic clutch having the above structure according to an embodiment of the present invention, the rotation limit member includes: a main body portion that is slidably inserted into the electromagnetic coil portion; and a first flange portion that is formed on an end portion of the main body portion that faces the sun gear; wherein a projection portion is formed on a portion of the sun gear that faces the first flange portion, an engagement portion that engages with the projection portion is formed on the first flange portion, and the elastic member is disposed between the first flange portion and the electromagnetic coil portion.

According to this structure, because the clutch goes into the connection state with the electricity supply to the electromagnetic coil portion 7 being in the OFF state, it is possible to achieve an advantageous structure in a use state in which the connection time of the clutch is longer than the interruption time of the clutch.

Besides, in the electromagnetic clutch having the above structure according to an embodiment of the present invention, the rotation limit member includes: a main body portion that is slidably inserted into the electromagnetic coil portion; a first flange portion that is formed on an end portion of the main body portion that faces the sun gear; and a second flange portion that is formed on an end portion of the main body portion opposite to the sun gear with the electromagnetic coil portion interposed; wherein a projection portion is formed on a portion of the sun gear that faces the first flange portion, an engagement portion that engages with the projection portion is formed on the first flange portion, and the elastic member is disposed between the second flange portion and the electromagnetic coil portion.

According to this structure, because the clutch goes into the connection state with the electricity supply to the electromagnetic coil portion being in the ON state, it is possible to achieve an advantageous structure in a use state in which the interruption time of the clutch is longer than the connection time of the clutch.

Besides, in the electromagnetic clutch having the above structure according to an embodiment of the present invention, the drive force is input into the internal gear and the drive force is output from the carrier.

According to this structure, the planetary gear-type electromagnetic clutch that has both of the clutch mechanism and the speed-reduction function is achieved.

Besides, in the electromagnetic clutch having the above structure according to an embodiment of the present invention, the rotation limit member includes: a main body portion that is slidably inserted into the electromagnetic coil portion; a first flange portion that is formed on an end portion of the main body portion that faces the internal gear; wherein a projection portion is formed on a portion of the internal gear that faces the first flange portion, an engagement portion that engages with the projection portion is formed on the first flange portion, and the elastic member is disposed between the first flange portion and the electromagnetic coil portion.

According to this structure, because the clutch goes into the connection state with the electricity supply to the electromagnetic coil portion being in the OFF state, it is possible to achieve an advantageous structure in a use state in which the connection time of the clutch is longer than the interruption time of the clutch.

Besides, in the electromagnetic clutch having the above structure according to an embodiment of the present invention, the drive force is input into the sun gear and the drive force is output from the carrier.

According to this structure, the planetary gear-type electromagnetic clutch that has both of the clutch mechanism and the speed-reduction function is achieved.

Besides, in the electromagnetic clutch having the above structure according to an embodiment of the present invention, the internal gear is composed of: a first internal gear that is disposed adjacently to the rotation limit member; and a second internal gear that is disposed on a side opposite to the rotation limit member with the first internal gear interposed; and the rotation limit member is selectively disposed at a first position for limiting rotation of the first internal gear or at a second position for permitting the rotation of the first internal gear.

According to this structure, it is possible to obtain a higher speed-reduction ratio, which is suitable for the size reduction and space saving of the drive apparatus that includes the clutch and contributes to the reduction in the number of components and to the low cost due to the simplification of the production process.

Besides, in the electromagnetic clutch having the above structure according to an embodiment of the present invention, the rotation limit member includes: a main body portion that is slidably inserted into the electromagnetic coil portion; and a first flange portion that is formed on an end portion of the main body portion that faces the first internal gear; wherein a projection portion is formed on a portion of the first internal gear that faces the first flange portion, an engagement portion that engages with the projection portion is formed on the first flange portion, and the elastic member is disposed between the first flange portion and the electromagnetic coil portion.

According to this structure, because the clutch goes into the connection state with the electricity supply to the electromagnetic coil portion being in the OFF state, it is possible to achieve an advantageous structure in the use state in which the connection time of the clutch is longer than the interruption time of the clutch.

Besides, in the electromagnetic clutch having the above structure according to an embodiment of the present invention, the rotation limit member includes: a main body portion that is slidably inserted into the electromagnetic coil portion; a first flange portion that is formed on an end portion of the main body portion that faces the first internal gear; and a second flange portion that is formed on an end portion of the main body portion opposite to the first internal gear with the electromagnetic coil portion interposed; wherein a projection portion is formed on a portion of the first internal gear that faces the first flange portion, an engagement portion that engages with the projection portion is formed on the first flange portion, and the elastic member is disposed between the second flange portion and the electromagnetic coil portion.

According to this structure, because the clutch goes into the connection state with the electricity supply to the electromagnetic coil portion being in the ON state, it is possible to achieve an advantageous structure in the use state in which the interruption time of the clutch is longer than the connection time of the clutch.

Besides, in the electromagnetic clutch having the above structure according to an embodiment of the present invention, in the planetary gear, the number of teeth of a first mesh portion that meshes with the first internal gear and the number of teeth of a second mesh portion that meshes with the second internal gear are different from each other.

According to this structure, it is possible to arbitrarily set the speed-reduction ratio of the drive output side to the drive input side with a simple structure.

Besides, in the electromagnetic clutch having the above structure according to an embodiment of the present invention, the number of teeth of the first internal gear and the number of teeth of the second internal gear are different from each other.

According to this structure, it is possible to arbitrarily set the speed-reduction ratio of the drive output side to the drive input side with a simple structure.

The embodiments of the present invention are applicable to a planetary gear-type clutch that has a planetary gear mechanism which includes an internal gear, a sun gear, a planetary gear and a carrier.

What is claimed is:

1. A planetary gear-type electromagnetic clutch comprising:
an internal gear which includes a gear tooth formed on an inner-surface side thereof and is rotatable;
a sun gear that is disposed on the same shaft as the rotational shaft of the internal gear and includes a gear tooth formed on an outer circumferential surface thereof;
a planetary gear that meshes with the sun gear and the internal gear;
a carrier that rotatably supports the planetary gear and rotatably disposed on the same shaft as the rotational shaft;
a rotation limit member that is disposed on the same shaft as the rotational shaft and is selectively disposed at a first position for limiting rotation of the internal gear or the sun gear and at a second position for permitting rotation of the internal gear and the sun gear; and
a drive mechanism that is disposed on the same shaft as the rotational shaft and switches the rotation limit member to a first position or to a second position.

2. The planetary gear-type electromagnetic clutch according to claim 1, wherein
the rotation limit member is formed of a magnetic material and the drive mechanism is composed of: an elastic member that energizes the rotation limit member to the first position or the second position; and an electromagnetic coil portion that forms a magnetic circuit by being supplied with electricity to move the rotation limit member in a direction opposite to energizing force of the elastic member.

3. The planetary gear-type electromagnetic clutch according to claim 2, wherein
the rotation limit member includes: a main body portion that is slidably inserted into the electromagnetic coil portion; and a first flange portion that is formed on an end portion of the main body portion that faces the sun gear; wherein a projection portion is formed on a portion of the sun gear that faces the first flange portion, an engagement portion that engages with the projection portion is formed on the first flange portion, and the elastic member is disposed between the first flange portion and the electromagnetic coil portion.

4. The planetary gear-type electromagnetic clutch according to claim 2, wherein
the rotation limit member includes: a main body portion that is slidably inserted into the electromagnetic coil portion; a first flange portion that is formed on an end portion of the main body portion that faces the sun gear; and a second flange portion that is formed on an end portion of the main body portion opposite to the sun gear with the electromagnetic coil portion interposed; wherein a projection portion is formed on a portion of the sun gear that faces the first flange portion, an engagement portion that engages with the projection portion is formed on the first flange portion, and the elastic member is disposed between the second flange portion and the electromagnetic coil portion.

5. The planetary gear-type electromagnetic clutch according to claim 3, wherein drive force is input into the internal gear and the drive force is output from the carrier.

6. The planetary gear-type electromagnetic clutch according to claim 4, wherein drive force is input into the internal gear and the drive force is output from the carrier.

7. The planetary gear-type electromagnetic clutch according to claim 2, wherein
the rotation limit member includes: a main body portion that is slidably inserted into the electromagnetic coil portion; a first flange portion that is formed on an end portion of the main body portion that faces the internal gear; wherein a projection portion is formed on a portion of the internal gear that faces the first flange portion, an engagement portion that engages with the projection portion is formed on the first flange portion, and the elastic member is disposed between the first flange portion and the electromagnetic coil portion.

8. The planetary gear-type electromagnetic clutch according to claim 7, wherein drive force is input into the sun gear and the drive force is output from the carrier.

9. The planetary gear-type electromagnetic clutch according to claim 2, wherein
the internal gear is composed of: a first internal gear that is disposed adjacently to the rotation limit member; and a second internal gear that is disposed on a side opposite to the rotation limit member with the first internal gear interposed; and
the rotation limit member is selectively disposed at a first position for limiting rotation of the first internal gear or at a second position for permitting the rotation of the first internal gear.

10. The planetary gear-type electromagnetic clutch according to claim 9, wherein
the rotation limit member includes: a main body portion that is slidably inserted into the electromagnetic coil portion; and a first flange portion that is formed on an end portion of the main body portion that faces the first internal gear; wherein a projection portion is formed on a portion of the first internal gear that faces the first flange portion, an engagement portion that engages with the projection portion is formed on the first flange portion, and the elastic member is disposed between the first flange portion and the electromagnetic coil portion.

11. The planetary gear-type electromagnetic clutch according to claim 9, wherein
the rotation limit member includes: a main body portion that is slidably inserted into the electromagnetic coil portion; a first flange portion that is formed on an end portion of the main body portion that faces the first internal gear; and a second flange portion that is formed on an end portion of the main body portion opposite to the first internal gear with the electromagnetic coil portion interposed; wherein a projection portion is formed on a portion of the first internal gear that faces the first flange portion, an engagement portion that engages with the projection portion is formed on the first flange portion, and the elastic member is disposed between the second flange portion and the electromagnetic coil portion.

12. The planetary gear-type electromagnetic clutch according to claim 9, wherein
in the planetary gear, the number of teeth of a first mesh portion that meshes with the first internal gear and the number of teeth of a second mesh portion that meshes with the second internal gear are different from each other.

13. The planetary gear-type electromagnetic clutch according to claim 10, wherein
in the planetary gear, the number of teeth of a first mesh portion that meshes with the first internal gear and the number of teeth of a second mesh portion that meshes with the second internal gear are different from each other.

14. The planetary gear-type electromagnetic clutch according to claim 11, wherein
in the planetary gear, the number of teeth of a first mesh portion that meshes with the first internal gear and the number of teeth of a second mesh portion that meshes with the second internal gear are different from each other.

15. The planetary gear-type electromagnetic clutch according to claim 9, wherein
the number of teeth of the first internal gear and the number of teeth of the second internal gear are different from each other.

16. The planetary gear-type electromagnetic clutch according to claim 10, wherein
the number of teeth of the first internal gear and the number of teeth of the second internal gear are different from each other.

17. The planetary gear-type electromagnetic clutch according to claim 11, wherein
the number of teeth of the first internal gear and the number of teeth of the second internal gear are different from each other.

18. The planetary gear-type electromagnetic clutch according to claim 12, wherein
the number of teeth of the first internal gear and the number of teeth of the second internal gear are different from each other.

19. The planetary gear-type electromagnetic clutch according to claim 13, wherein
the number of teeth of the first internal gear and the number of teeth of the second internal gear are different from each other.

20. The planetary gear-type electromagnetic clutch according to claim 14, wherein
the number of teeth of the first internal gear and the number of teeth of the second internal gear are different from each other.
